(19) United States
(12) Patent Application Publication
(10) Pub. No.: US 2007/0091075 A1
(43) Pub. Date: Apr. 26, 2007

(54) Method for window operation on a touchpad using a touch defined original point

(76) Inventor: Jia-Yih Lii, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/545,503

(22) Filed: Oct. 11, 2006

(30) Foreign Application Priority Data
Oct. 25, 2005 (TW) 094137355

(51) Int. Cl. G09G 5/00

(52) U.S. Cl. 345/173

(57) ABSTRACT

In a method for window operation on a touchpad, when an object is detected to slide on the touchpad, the position where the object falls down to touch the touchpad is defined as an original point, and a position where the object stops sliding on the touchpad is referred to a relative position, a direction and a difference value are determined upon the original point and the relative position, and a signal is produced according to the direction and the difference value to send to a host to trigger a window operation.

### FIELD OF THE INVENTION

The present invention is related generally to a control method for window operation with a touchpad and, more particularly, to a method for window operation on a touchpad using a touch defined original point.

### BACKGROUND OF THE INVENTION

Along with the sizes of electronic products becoming smaller and smaller, touchpads have been popular input devices of electronic products due to its advantages such as thin and small, light weight, low cost, low power consumption, and long lifetime. Conventionally, using a touchpad to carry out a window operation needs to predefine a fixed position on the touchpad as the original point of a coordinate system and predefine a fixed operational region on the touchpad based on the original point. For example, in the method and apparatus for scroll bar control provided by U.S. Pat. No. 5,943,052 to Allen et al., it needs to define a fixed original point on a touchpad first and then define a fixed scroll region on the touchpad, either in vertical direction or in horizontal direction, with the original point as a reference. A vertical scroll bar control is illustrated in further detail with reference to FIG. 1, in which a touchpad 100 includes a predefined vertical scroll region 110 corresponding to a vertical scroll bar 130 of a window 120, and the vertical scroll region 110 is defined with an original point, typically at the left bottom corner, as the coordinating reference. When an object touching on the touchpad 100 moves from a position 140 to a position 150 within the vertical scroll region 110 with a vertical distance ΔF, this action will be processed by the processor of the touchpad 100 to produce a vertical scroll signal to send to the operational system running with the window 120. Hence the vertical scroll bar 130 and thereby the window 120 will be scrolled in the same direction as the object's moving direction with a scroll distance ΔT proportional to the moving distance ΔF. With this control method, the object must move repeatedly for scrolling the window 120 to the target range if it is far away from the current range. Moreover, it needs an effective trigger to the vertical scroll region 110 for starting the scroll function; otherwise the scroll on the window 120 won't be achieved. FIGS. 2A-2C show some typical operations on the touchpad 100 which will not result in effective triggers to the vertical scroll region 110. As shown in FIG. 2A, if the object moves from a position X outside the vertical scroll region 110 to inside the vertical scroll region 110, it won't trigger the scroll function of the vertical scroll region 110. In FIG. 2B, the object moves from a position X inside the vertical scroll region 110 to outside the vertical scroll region 110, and it will cause the scroll function of the vertical scroll region 110 to fail. In FIG. 2C, if the moving direction of the object sliding within the vertical scroll region 110 is not parallel to the vertical axis 160 of the vertical scroll region 110, this movement operation will be ignored by the processor of the touchpad 100 and will not cause the vertical scroll bar 130 of the window 120 to scroll. These conditions inconvenience users to operate with a touchpad for scroll bar control. Further, touchpads become smaller and smaller with the reducing of the size of electronic products, and thereby defining several operational regions on a touchpad will make each operational region too small for object operation.

Therefore, it is desired a method for window operation on a touchpad without predefined operational region and avoiding repeated object movement.

### SUMMARY OF THE INVENTION

An object of the present invention is to provide a method for window operation on a touchpad using a touch defined original point.

In a method for window operation on a touchpad, according to the present invention, when an object is detected to slide on the touchpad, the position where the object falls down to touch the touchpad is defined as an original point, a position where the object stops sliding on the touchpad in a movement is referred to a relative position, a direction and a difference value are determined upon the original point and the relative position, and a signal is produced according to the direction and the difference value to send to a host to trigger a window operation.

When operating with a touchpad, according to the present invention, the touchpad has a touch defined original point which varies with each object operation, depending on where the object falls down to touch the touchpad this time. Once the object leaves the touchpad and falls down to touch the touchpad again, a different original point from the last object operation is defined. Since no fixed original point is predefined on the touchpad, there is no need of a fixed operational region to be predefined on the touchpad. For a scroll bar control, the whole touchpad may become a scroll region, and it is larger than any predefined operational region. Further, the vertical scrolling and the horizontal scrolling may be combined in a single object movement. For other window operations, it also has a larger operational region.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a scroll bar control to a window by operating with a conventional method and touchpad;

FIGS. 2A-2C show some typical operations on the touchpad of FIG. 1 which will not result in effective triggers to the scroll region on the touchpad;

FIG. 3 shows an original point setting in an embodiment according to the present invention;

FIG. 4 shows an operation on a touchpad in an embodiment according to the present invention;

FIG. 5 shows a scroll bar control to a window corresponding to the operation shown in FIG. 4;

FIG. 6 shows a menu selection on a window corresponding to the operation shown in FIG. 4; and

FIG. 7 shows a menu scroll control on a window corresponding to the operation shown in FIG. 4.

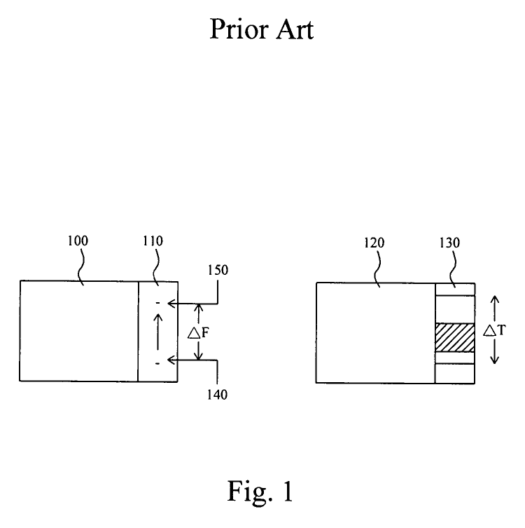

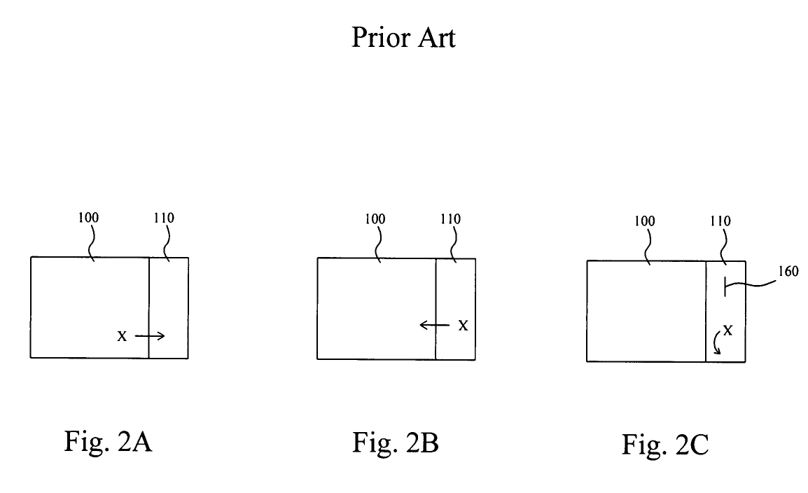

### DETAILED DESCRIPTION OF THE INVENTION

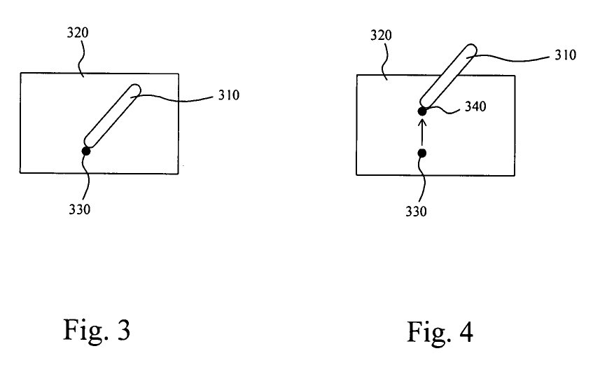

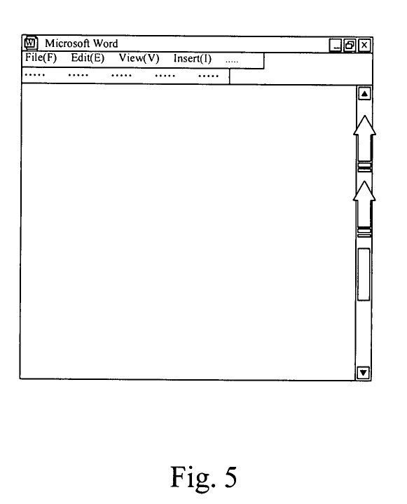

Referring to FIGS. 3 and 4, if an object 310 (e.g., a finger or a conductive object such as touch control pan, or their combination) is detected by a touchpad 320 to slide thereon, the position 330 where the object 310 falls down to touch the touchpad 320 is defined to be the original point by the touchpad 320 in this operation, and a position 340 where the object 310 stops sliding on the touchpad 320 is referred to a relative position. A direction and a difference value are determined by the touchpad 320 upon the relative position 340 and the original point 330 for this operation to produce a signal to send to a host to carry out a window operation. In this method, no fixed original point is predefined on the touchpad 320, and any position on the touchpad 320 could be defined as the original point. Once the object 310 leaves the touchpad 320 and falls down to touch the touchpad 320 again, a different original point 330 from the last object operation is defined. Each time the object 310 falls down to touch the touchpad 320, an original point 330 is defined, and with this original point as the reference, the movement of the object 310 can determine a corresponding window operation. Further, no fixed operational region is predefined on the touchpad 320, and the whole touchpad 320 may serve as a large operational region for the object 310 to operate therewithin. For example, in a scroll bar control to a window, as shown in FIG. 5, if the direction of the relative position 340 relative to the original point 330 is upward, the signal sent to the host will include an upward difference value to trigger the window to scroll upward. In different operation, if the direction of the relative displacement is downward, the signal sent to the host will include a downward difference value to trigger the window to scroll downward. Likewise, if the direction of the relative displacement is leftward, the signal sent to the host will include a leftward difference value to trigger the window to scroll leftward, and if the direction of the relative displacement is rightward, the signal sent to the host will include a rightward difference value to trigger the window to scroll rightward. Alternatively, the vertical scrolling and the horizontal scrolling may be combined in a single object movement. For example, the direction from the position 330 to the position 340 determines a scroll direction which may include a vertical direction and a horizontal direction simultaneously, and the distance between the positions 330 and 340 determines a scroll distance which may include a vertical distance and a horizontal distance.

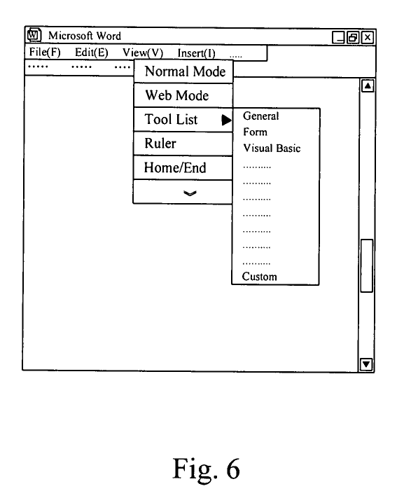

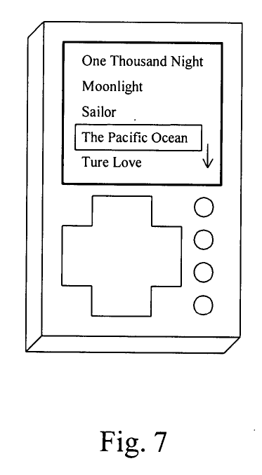

In some other embodiments, the direction and the difference value of the relative position 340 relative to the original point 330 may refer to specific direction such as up and down, or forward and backward, and cursor movement magnitude, so that a corresponding signal including the information of the direction and the difference value is produced to send to a host, to trigger various window operations, such as selecting on a menu or scrolling a menu on a window, as shown in FIGS. 6 and 7.

In the method according to the present invention, it is determined by user the original point as the basis to produce the signal including the direction and the difference value for the host to trigger window operations such as scrolling a window, selecting on a menu, and scrolling a menu. Users don't need to move repeatedly or do any gesture on the touchpad. It also doesn't need to predefine any operational region or specific functional region on the touchpad. Therefore, the user's operation is improved and simplified.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set fourth in the appended claims.

What is claimed is:

1. A method for window operation on a touchpad, comprising the steps of:
detecting if an object sliding on a touchpad;
defining the position where the object falls down to touch the touchpad as an original point if it is detected an object sliding on the touchpad in the previous step;
detecting a position where the object stops sliding on the touchpad for being referred to a relative position;
determining a direction and a difference value upon the original point and the relative position; and
producing a signal according to the direction and the difference value for sending to a host to trigger a window operation.

2. The method of claim 1, wherein the window operation comprises scrolling a window, selecting on a menu, or scrolling a menu.
